(19) United States
(12) Patent Application Publication
(10) Pub. No.: US 2009/0012224 A1
(43) Pub. Date: Jan. 8, 2009

(54) Polyolefin Compositions Comprising Hydrated Inorganic or Organic Compounds for the Prevention of Discoloration

(75) Inventors: Christoph Krohnke, Breisach-Oberrimsingen (DE); Jan Malik, St. Louis (FR); Peter Staniek, Binzen (DE); Gert Berendsen, Philippine (NL); Robin J. Lee, Lake Jackson, TX (US); Thoi H. Ho, Lake Jackson, TX (US)

Correspondence Address: CLARIANT CORPORATION;INTELLECTUAL PROPERTY DEPARTMENT, 4000 MONROE ROAD, CHARLOTTE, NC, 28205, US

(73) Assignee: CLARIANT INTERNATIONAL LTD, Muttenz (CH)

(21) Appl. No.: 10/590,097

(22) PCT Filed: Feb. 4, 2005
(86) PCT No.: PCT/IB2005/000311

§ 371 Date: Sep. 17, 2008

(30) Foreign Application Priority Data
Feb. 17, 2004 (EP) 04003489.4
Apr. 22, 2004 (EP) 04009516.8

(51) Int. Cl. C08K 3/32

(52) U.S. Cl. 524/417

(57) ABSTRACT

The invention relates to a polyolefin composition comprising a water releasing additive comprising hydrated inorganic or organic compounds as well as to a process for prevention of discoloration in polyolefins.

The invention relates to a polyolefin composition comprising a water releasing additive comprising hydrated inorganic or organic compounds as well as to a process for prevention of discoloration in polyolefins.

Discoloration of polyolefins either directly after manufacture or after processing is a well known phenomenon. Discoloration in polyolefins can be caused by various reasons. On a longer time scale, usually during the lifetime of the polyolefin article, discoloration occurs due to the transformation of phenol based antioxidants into products with quinoid structures (P. P Klemchuk and P. L. Horng, Polym.Degrad. Stab. 7, 131 (1984); T. J Henman in Development in Polymer Stabilization-1, editor G. Scott, Applied Science Publishers, London, p.39 (1979); G. Scott and F. Yusoff, Polym.Degrad. Stab. 3, 13 (1980)). As a consequence, in subsequent publications (e.g. E. Epacher, E. Fekete, M. Gahleitner and B. Pukanszky, Polym.Degrad. Stab. 63, 489 (1999)) it is assumed that discoloration is proportional to the amount of stabilizer which reacts during the processing of the polyolefin which has been treated quantitatively.

In other literature, it is reported that discoloration of polyolefins is particularly pronounced if they are in continuous contact with water (H. R. Smeltz and W. Krucker, Textilveredlung, 20[9], 272 (1985)). Meanwhile, several stabilizer systems have been developed against the auto-oxidation process that can occur in the presence of transition metal ions e.g. from metal cable components.

Hydroperoxide decomposition, which may be involved in such auto-oxidation, is known to be catalyzed by transition metal impurities, usually metal catalyst residues such as titanium and aluminum residues left from the polymerization (Y. Kamiya, J. Polym. Sci., B-4, 999 (1966), R. Hiatt, T. Mill and F. R. Mayo, J.Org. Chem., 33, 1416 (1968); L. Reich, B. R. Jadrnicek, and S. S. Stivala, Polym. Eng. Sci., 11, 265 (1971); D. J. Carlson and D. M. Wiles, J. Macromol. Sci., Rev. Macromol. Chem., C-14, 65 (1976)).

In classical Ziegler based catalyst compositions, titanium and aluminum can be neutralized by adding water and / or alcohols to the system to form hydroxide or alkoxide derivatives, e.g. aluminum and titanium isopropoxides which during processing convert to the corresponding oxides of titanium and aluminum, or in the form of nanometer sized particles embedded within the particles of the resulting resin.

With later generation catalysts and corresponding polyolefins, Lewis acid residues in combination with residues of selectivity control agents can still lead to discoloration.

WO 99/67322 (EP-A-1090065) discloses foamable thermoplastic polyolefin elastomer compositions containing hydrated salts of Group 1 and 2 metals, especially metal hydroxides. Similarly, WO 98/37131 (EP-A-0961808) describes foamable polyolefin elastomer compositions comprising hydrated metal salts, especially aluminum and magnesium hydroxides which may be surface treated with coupling agents.

U.S. Pat. No. 4,298,509 discloses fire resistant polyolefin fibers containing metal oxide hydrates together with halogenated organic compounds, ammonium-polyphosphates or metal borates. Similar additives for polyolefin resins include hydrotalcite or synthetic hydrotalcite [Mg₆Al₂(OH)₁₆](CO₃)(H₂O)₄, which generate carbon dioxide upon heating.

Porous laminated polyolefin sheets prepared by processing resins which contain up to 10 percent by weight of hydrated inorganic compounds, especially aluminum hydroxide and calcium carbonate are disclosed in JP-A-52/078279.

In JP-B-45/035372, polyethylene films are prepared from polymers containing hydrated salts, such as ferric ammonium alum. Such compounds however are pink or violet colored and accordingly of limited usefulness in polymer modification.

Despite the advances in the art occasioned by the foregoing polymer compositions, simple procedures to reduce or eliminate color formation in olefin polymers are still desired. In particular, a suitable process that utilize small quantities of colorless compounds that may be readily employed in polyolefin resins made via solution polymerization techniques is still desired.

JP-A-52/049258 (Mitsubishi Perochemical Co Ltd.) discloses a rust preventing anti yellowing Ziegler type polyolefin composition comprising 0.1 to 1 percent by weight of hydrated alkaline earth metal carbonate and/or hydroxide compounds as well as hydrated Mg/Al carbonate and/or hydroxide compounds, preferably hydrated Mg carbonate and/or hydroxide compounds.

U.S. Pat. No. 4,591,633 (Suzuki et al.) discloses a deodorizing Ziegler type polyolefin composition comprising 0.001 to 0.5 percent by weight of hydrated Mg or Mg/Al carbonate and/or hydroxide compounds or hydrated Ca-/Al4Si-oxide compounds.

U.S. Pat. No. 4,284,762 (Miyata et al.) discloses a corrosion inhibiting, discoloration preventing polyolefin composition comprising 0.01 to 5 percent by weight of a hydrotalcite, preferably Mg₁₋ₓAlₓ(OH)₂(CO₃))_{x/n}ⁿ⁻¹·m H₂O.

Surprisingly it now has been found that specific hydrated inorganic or organic compounds are suitable as water releasing additives preventing or reducing color body formation in polyolefins.

The polyolefin composition according to the invention comprises colorless water releasing additives in concentrations from 0.001 to 1 weight percent, based on the weight of the polyolefin mass, wherein the water releasing additive is a hydrated inorganic or organic compound according to the general formula:

(M(1)^{a+})ₗ (M(2)^{b+})ₘ(X^{c-})ₙ(H₂O)ₓ

in which

M(1)^{a+}=NH₄⁺, Na⁺, K⁺, Ca²⁺,Mg²⁺;

M(2)^{b+}=NH₄⁺, Na⁺, K⁺, Ca²⁺,Mg²⁺,

X^{c-}=BO₂²⁻, B₄O₇²⁻, PO₄³⁻, HPO₄²⁻, H₂PO₄₋, P₂O₇⁴⁻, oxalate²⁻, citrate³⁻, lactate⁻,

l*a+m*b=n*c and x=1−24,

and mixtures of the foregoing.

Preferably the water releasing additive is selected from (NH₄)₂B₄O₇·4H₂O, NH₄HB₄O₇·3H₂O, NH₄HC₂O₄·H₂O, (NH₄)₂C₂O₄·H₂O, (NH₄)₂HPO₃·H₂O, Ca(C₂H₃O₂)₂·H₂O, CaC₂O₄·H₂O, Ca(H₂PO₄)₂·H₂O, Mg(C₂H₃O₂)₂·4H₂O, K₂C₂O₄·H₂O, NaKC₂O₄·4H₂O, K₂HPO₄·3H₂O, K₄P₂O₇·3H₂O, K₂B₄O₇·5H₂O, K₃citrate·H₂O, K₂tartrate·xH₂O, NaC₂H₃O₂·3H₂O, NaNH₄HPO₄·4H₂O, Na₂CO₃·10H₂O, Na₂CO₃·H₂O, Na₃C₆H₅O₇·2H₂O, Na₂C₆H₆O₇·1.5H₂O, NaC₆H₇O₇·3H₂O, NaH₂PO₄·H₂O, NaH₂PO₄·2H₂O, Na₂HPO₄·2(H₂O), Na₂HPO₄·12H₂O, Na₂HPO₄·7H₂O, Na₃PO₄·12H₂O, NaK(C₄H₄O₆)·4H₂O, Na₂SO₄·10H₂O, Na₂B₄O7-1OH₂O, Na₂B₄O₇-5H₂O, Na₂B₄O₇-4H₂O, Na₄P₂O₇·12H₂O, Na₂HPO₄·xH₂O, trisodiumcitrate·2 H₂O, disodium citrate·1,5 H₂O, sodium citrate·H₂O, sodium lactate·x H₂O.

More preferably the water releasing additive is selected from K₂HPO₄·3H₂O, K₄P₂O₇·3H₂O, K₂B₄O₇·5H₂O, Na₂CO₃·10H₂O, Na₂CO₃·H₂O, Na₃C₆H₅O₇·2H₂O, Na₂C₆H₆O₇·1.5H₂O, NaC₆H₇O₇·3H₂O, NaH₂PO₄·H₂O, NaH₂PO₄·2H₂O, Na₂HPO₄·2(H₂O), Na₂HPO₄·12H₂O, Na₂HPO₄·7H₂O, Na₃PO₄·12H₂O, Na₂SO₄·10H₂O, Na₂B₄O₇·10H₂O, Na₂B₄O₇·5H₂O, Na₂B₄O₇·4H₂O, Na₄P₂O₇·12H₂O, Na₂HPO₄·5H₂O, i.e. the more preferred M(1)^{a+} and M(2)^{b+} being Na⁺ and K⁺ and the more preferred X^{c-} being B₄O₇²⁻, PO₄³⁻, HPO₄²⁻, H₂PO₄⁻, P₂O₇⁴⁻.

Most preferably the water releasing additive is selected from phosphates, hydrogenphosphates, dihydrogenphosphates and pyrophosphates of the following list K₂HPO₄·3H₂O, K₄P₂O₇·3H₂O, NaH₂PO₄·H₂O, NaH₂PO₄·2H₂O, Na₂HPO₄ ·2(H₂O) Na₂HPO₄·12H₂O, Na₂HPO₄·7H₂O, Na₃PO₄·12H₂O, Na₄P₂O₇·12H₂O, Na₂HPO₄·5H₂O. i.e. the most preferred M(1)^{a+} and M(2)^{b+} being Na⁺ and K⁺ and the most preferred X^{c-} being PO₄³⁻, HPO₄²⁻, H₂PO₄⁻, P₂O₇⁴⁻.

The polyolefin composition according to the invention comprises a polyolefin and from 0.001 to 1 percent by weight, preferably from 0.003 to 0.1 percent by weight, more preferably from 0.01 to 0.07 percent by weight of a colorless, hydrated inorganic or organic compound as a water releasing additive homogeneously incorporated therein.

Colorless in terms of the invention is defined as having a whiteness index (WI, determined according to ASTM-E-313.00) in the solid particulated form from 70 to 100, preferably from 80 to 100.

The water releasing additives are further capable of forming an aqueous solution at 25° C. having a pH of from 2.0 to 10.0, preferably from 3.0 to 8.0. It is desirable that the composition does not evolve gaseous by-products, especially CO₂ upon melt processing thereof.

The polyolefins which are used as substrates according to the invention can be:
1. Polymers of mono- and diolefins, for example polypropylene, polyisobutylene, polybut-1-ene, poly-4-methylpent-1-ene, polyisoprene or polybutadiene and polymers of cycloolefins such as cyclopentene or norbornene; in addition polyethylene (which may optionally be crosslinked), e.g. high-density polyethylene (HDPE), low-density polyethylene (LDPE), linear low-density polyethylene (LLDPE), branched low-density polyethylene (BLDPE). Polyolefins, i.e. polymers of monoolefins, in particular polyethylene and polypropylene, can be prepared by various processes, especially by the following methods:
   a) free-radical (usually at high pressure and high temperature).
   b) by means of a catalyst, where the catalyst usually comprises one or more metals of groups IVb, Vb, VIb or VIII. These metals usually have one or more ligands such as oxides, halides, alkoxides, esters, ethers, amines, alkyls, alkenyls and/or aryls, which can be either -π- or α-coordinated. These metal complexes can be free or fixed to supports, such as on activated magnesium chloride, titanium chloride, aluminum oxide or silicon oxide. These catalysts can be soluble or insoluble in the polymerization medium. The catalysts can be active as such in the polymerization, or other activators can be used, for example metal alkyls, metal hydrides, metal alkylhalides, metal alkyloxides or metal alkyloxanes, the metals being elements of Groups Ia, IIa and/or IIIa. The activators can be modified, for example, with further ester, ether, amine or silyl ether groups. These catalyst systems are usually termed Phillips, Standard Oil Indiana, Ziegler (Natta), TNZ (DuPont), metallocene or single site catalysts (SSC).
2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).
3. Copolymers of mono- and diolefins with one another or with other vinyl monomers, for example ethylene-propylene copolymers, linear low-density polyethylene (LLDPE) and mixtures thereof with low-density polyethylene (LDPE), propylene-but-i-ene copolymers, propylene-isobutylene copolymers, ethylene-but-1-ene copolymers, ethylene-hexene copolymers, ethylene-methylpentene copolymers, ethylene-heptene copolymers, ethylene-octene copolymers, propylene-butadiene copolymers, iso-butylene and isoprene copolymers, ethylene-alkyl acrylate copolymers, ethylene-alkyl methacrylate copolymers, ethylene-vinyl acetate copolymers and their copolymers with carbon monoxide or ethylene-acrylic acid copolymers and their salts (ionomers), as well as terpolymers of ethylene with propylene and a diene such as hexadiene, dicyclopentadiene or ethylidene-norbornene; in addition mixtures of such copolymers with one another and with polymers mentioned under 1), for example polypropylene/ ethylene-propylene copolymers, LDPE-ethylene-vinyl acetate copolymers, LDPE/ethylene-acrylic acid copolymers, LLDPE/ethylene-vinyl acetate copolymers, LLDPE/ethylene-acrylic acid copolymers and alternating or random polyalkylene-carbon monoxide copolymers and mixtures thereof with other polymers, for example polyamides.

Besides the water releasing additives according to the invention the polyolefins can contain all kinds of known additives, for example antioxidants, UV absorbers and light stabilizers, metal deactivators, phosphites and phosphonites, peroxide scavengers, basic costabilizers, nucleating agents, fillers and reinforcing agents, as well as other additives such as plasticizers, lubricants, emulsifiers, pigments, optical brighteners, flameproofing agents, antistatics, blowing agents.

Specifically disclosed are calcium stearate, zinc stearate, synthetic hydrotalcite, in particular DHT4A, and mixtures thereof.

In a preferred aspect of the invention the polyolefin composition comprises a blend of a water releasing additive as defined above with calcium stearate or zinc stearate or DHT4A in a blend ratio from 10:90 to 90:10 by weight.

Any additional additives can be added to the polyolefins before, together with or after addition of the additives of the invention. These additional additives can be added as solids, in solution or melt as well as in the form of solid or liquid mixtures or masterbatches/concentrates.

Preferred combinations consist of polyolefins prepared with a titanium and magnesium containing Ziegler-Natta catalyst compositions. The Ti catalyst composition is preferably prepared by combining a hydrocarbon slurry of anhydrous magnesium dichloride, a hydrocarbon solution of ethylaluminum dichloride and a hydrocarbon solution of titanium tetraalkoxides, especially titanium tetra(isopropoxide) to yield a composition containing a magnesium concentration from 0.1 to 0.5 M, a molar ratio of Mg/Ti of 40/1 to 5/1, and a molar ratio of Ti/Al from 1/1 to 1/10. Activation of the compound is with an aluminum trialkyl compound, especially triethylaluminum.

The invention further relates to a process for the prevention of discoloration in polyolefins characterized by the addition of a hydrated inorganic or organic compound as characterized in claims 1 to 5 to a polyolefine in concentrations from 0.001 to 1 weight percent, based on the weight of the polyolefin mass.

The hydrated organic or inorganic compound is preferably added to the polymer formed in a polymerization process prior to devolatilization and/or melt extrusion and/or pelletizing. For example, in a solution polymerization process it is conveniently added to the solution exiting the reactor, desirably in the form of a solution or suspension of the additive compound. Further, the compound or a solution thereof, or a suspension thereof, can be added to the slurry exiting a slurry polymerization process or to the polymer powder recovered from a gas-phase process.

The additive compound can also be incorporated into a molten polymer mass in the form of a concentrate or masterbatch, which can comprise one or more additional polymers.

The preferred process for incorporating is a melt mixing process.

Surprisingly, the water releasing compounds are effective at suppressing discoloration during melt extrusion at very low concentrations without adverse impact on various polymer properties or on stabilizers or other additives normally added to such polymers.

The invention is now illustrated by the following examples:

### EXAMPLES

A high density polyethylene (HD 12450 N (available from The Dow Chemical Co.) is extruded multiple times. Polymer with and without powdered hydrated salt and a common stabilizer package comprising 0.02 wt-% Hostanox® O 10, 0.025 wt-% Hostanox® O 16, and 0.100 wt-% Hostanox® PAR 24 (all available from Clariant) is first mixed (dry blended) then extruded in a pre-extrusion step at 210° C. using a single screw extruder (screw diameter 25 mm (UD=25), compression 1:3, screw speed 60 rpm, die diameter 4 mm). Subsequent extrusions were then carried out using a single screw extruder at 240° C. (screw diameter 20 mm (UD=20), compression 1:3, screw speed 70 rpm, die diameter 2 mm). The extrudate is formed into compression molded test plates. A uniform quantity of titanium tetraisopropoxide (0.001% based on polymer weight) is added to all formulations (except the base reference) to simulate titanium residues.

Color (yellowness index, YI) is measured for each formulation after the pre-extrusion, first, third, and fifth extrusions by means of a Minolta CM 3500d spectrocolorimeter. Results are contained in TABLE 1.

TABLE 1

| | | YI | YI | YI | YI |
|---|---|---|---|---|---|
| Ex. | Formulation | (pre-extr.) | (1) | (3) | (5) |
| A* | base reference | 0.45 | 5.51 | 8.03 | 10.31 |
| 1 | 0.037 wg-% Na₄P₂O₇•10H₂O | −0.18 | 5.24 | 6.56 | 8.73 |
| 2 | 0.016 wg-% Na₂HPO₄•7H₂O | −0.22 | 4.69 | 6.31 | 8.57 |
| 3 | 0.065 wg-% Na₂HPO₄•7H₂O | −0.55 | 4.95 | 6.90 | 8.22 |

*comparative not an example of the invention

The test conditions of Examples 1-3 were substantially repeated with 0.003 weight percent titanium tetraisopropoxide instead of 0.001 weight percent titanium tetraisopropoxide added to each sample (except the base reference). Results are contained in TABLE 2.

TABLE 2

| | | YI | YI | YI | YI |
|---|---|---|---|---|---|
| Ex. | Formulation | (pre-extr.) | (1) | (3) | (5) |
| A* | base reference | 0.45 | 5.51 | 8.03 | 10.31 |
| 4 | 0.009 wg-% Na₄P₂O₇•10H₂O | −1.31 | 2.54 | 4.36 | 6.02 |
| 5 | 0.018 wg-% Na₄P₂O₇•10H₂O | −2.02 | 2.15 | 4.67 | 5.84 |
| 6 | 0.004 wg-% Na₂HPO₄•7H₂O | −1.41 | 2.62 | 4.93 | 6.18 |
| 7 | 0.015 wg-% Na₂HPO₄•7H₂O | −1.79 | 2.55 | 4.33 | 5.21 |

*comparative, not an example of the invention

1. Polyolefin composition comprising a water releasing additives in concentrations from 0.001 to 1 weight percent, based on the weight of the polyolefin mass wherein the water releasing additive is a hydrated inorganic or organic compound according to the general formula:
(M(1)^{a+})ₗ (M(2)^{b+})ₘ(X^{c-})ₙ(H₂O)ₓ
in which
M(1)^{a+}=NH₄⁺, Na⁺, K⁺, Ca²⁺,Mg²⁺;
M(2)^{b+}=NH₄⁺, Na⁺, K⁺, Ca²⁺,Mg²⁺,
X^{c-}=BO₂²⁻, B₄O₇²⁻, PO₄³⁻, HPO₄²⁻, H₂PO₄₋, P₂O₇⁴⁻, oxalate²⁻, citrate³⁻, lactate⁻,
l*a+m*b=n*c and x=1−24,
and mixtures of the foregoing.

2. Polyolefin composition according to claim 1 wherein the water releasing additive is selected from (NH₄)₂B₄O₇·4H₂O, NH₄HB₄O₇·3H₂O, NH₄HC₂O₄·H₂O, (NH₄)₂C₂O₄·H₂O, (NH₄)₂HPO₃·H₂O, Ca(C₂H₃O₂)₂·H₂O, CaC₂O₄·H₂O, Ca(H₂PO₄)₂·H₂O, Mg(C₂H₃O₂)₂·4H₂O, K₂C₂O₄·H₂O, NaKC₂O₄·4H₂O, K₂HPO₄·3H₂O, K₄P₂O₇·3H₂O, K₂B₄O₇·5H₂O, K₃citrate·H₂O, K₂tartrate·xH₂O, NaC₂H₃O₂·3H₂O, NaNH₄HPO₄·4H₂O, Na₂CO₃·10H₂O, Na₂CO₃·H₂O, Na₃C₆H₅O₇·2H₂O, Na₂C₆H₆O₇·1.5H₂O, NaC₆H₇O₇·3H₂O, NaH₂PO₄·H₂O, NaH₂PO₄·2H₂O, Na₂HPO₄·2(H₂O), Na₂HPO₄·12H₂O, Na₂HPO₄·7H₂O, Na₃PO₄·12H₂O, NaK(C₄H₄O₆)·4H₂O, Na₂SO₄·10H₂O, Na₂B₄O₇·10H₂O, Na₂B₄O₇·5H₂O, Na₂B₄O₇·4H₂O, Na₄P₂O₇·12H₂O, Na₂HPO₄·5H₂O, trisodiumcitrate·2 H₂O, disodium citrate·1,5 H₂O, sodium citrate·H₂O, sodium lactate·x H₂O.

3. Polyolefin composition according to claim 1 wherein the water releasing additive is selected from K₂HPO₄·3H₂O, K₄P₂O₇·3H₂O, K₂B₄O₇·5H₂O, Na₂CO₃·10H₂O, Na₂CO₃·H₂O, Na₃C₆H₅O₇·2H₂O, Na₂C₆H₆O₇·1.5H₂O, NaC₆H₇O₇·3H₂O, NaH₂PO₄·H₂O, NaH₂PO₄·2H₂O, Na₂HPO₄·2(H₂O), Na₂HPO₄·12H₂O, Na₂HPO₄·7H₂O, Na₃PO₄·12H₂O, Na₂SO₄·10H₂O, Na₂B₄O₇·10H₂O, Na₂B₄O₇·5H₂O, Na₂B₄O₇·4H₂O, Na₄P₂O₇·12H₂O, Na₂HPO₄·5H₂O.

4. Polyolefin composition according to claim 1 wherein the water releasing additive is selected from K₂HPO₄·3H₂O, K₄P₂O₇·3H₂O, NaH₂PO₄·H₂O, NaH₂PO₄·2H₂O, Na₂HPO₄·2(H₂O), Na₂HPO₄·12H₂O, Na₂HPO₄·7H₂O, Na₃PO₄·12H₂O, Na₄P₂O₇·12H₂O, Na₂HPO₄·5H₂O.

5. Polyolefin composition according to claim 1 wherein the concentration of the water releasing additives is from 0.003 to 0.1, preferably from 0.01 to 0.07 weight percent.

6. Polyolefin composition according to claim 1 wherein the additive is a blend of a water releasing additive according to claim 1 with calcium stearate or zinc stearate or DHT4A in a blend ratio from 10:90 to 90:10 by weight.

7. A process for the prevention of discoloration in polyolefins characterized by the addition of a hydrated inorganic or organic compound as characterized in claims 1 to 5 to a polyolefine in concentrations from 0.001 to 1 weight percent, based on the weight of the polyolefin mass.

8. A process according to claim 7 wherein the hydrated inorganic or organic compounds are added to the polyolefin polymer formed in any polymerization process prior to devolatilization and/or melt extrusion and pelletizing thereof.

9. A process according to claim 7 wherein the hydrated inorganic or organic compounds are incorporated into the molten polymer mass by means of a melt mixing process, preferably in the form of a concentrate or masterbatch.

10. Use of polyolefin composition as characterized in claims 1 to 6 for the prevention of discoloration in polyolefins.
